(19) United States
(12) Patent Application Publication
(10) Pub. No.: US 2025/0289083 A1
(43) Pub. Date: Sep. 18, 2025

(54) SWING ARM WELDING SYSTEM

(71) Applicant: Industrial Steel Construction, Inc., Gary, IN (US)

(72) Inventor: Francois Geneve, Lake Villa, IL (US)

(21) Appl. No.: 18/607,039

(22) Filed: Mar. 15, 2024

(51) Int. Cl. B23K 37/04; B23K 37/047; B23K 101/18

(52) U.S. Cl. CPC B23K 37/0408; B23K 37/0435; B23K 37/047; B23K 2101/18

(57) ABSTRACT

The invention relates to a system and method for the temporary mounting and stabilization of objects to be welded. The system includes a plurality of assembly stations configured to align adjacent objects for welding and allow for the secure and stable rotation of objects to further secure the weld on both sides of the joint.

### BACKGROUND OF THE INVENTION

The present invention generally relates to the field of welding support devices and systems. More particularly, the invention relates to a system configured to align and stabilize plates while welding a butt splice joint.

Joining two plates together through a weld requires the plates to be stabilized such that a strong consistent weld can be added. A stabilized plate needs to be aligned, secure, level and on plane with the adjacent plate to maintain a consistent surface. In order to strengthen the weld, it may be beneficial to be able to access both sides of the joint between plates.

The present invention attempts to remedy the shortcomings of prior art processes by providing a stable rotatable system to align plates for welding.

### SUMMARY OF THE INVENTION

In view of the above, a system comprising an assembly configured for the temporary mounting of at least one plate to facilitate its connection to an adjacent member is disclosed. The advantage of the present invention is that it allows for stability and accuracy in alignment to adjacent members while further allowing flexibility at a welding station to flip adjacently welded members to inspect and weld the opposite face of the weld joint.

In one aspect, the system comprises at least a first assembly station comprising a first support member and a second support member aligned with the first supported member, an adjustable clamping means extending from one of the support members configured to locate and secure an object between the support members, and a flip axle member engaging the first support member and second support member proximal respective adjacent and aligned ends such that the secured first and second support members to be flipped through 180 degrees of rotation and thereby invert the first and second support members and any object clamped between them.

In another aspect, the system comprises a plurality of assembly stations spaced apart from adjacent stations at a predetermined distance. In this aspect, the confronting edges of objects in said adjacent stations are in such proximity to one another that the adjacent clamped objects can be conjoined to one another. Example objects include but are not limited to metal plates aligned adjacently to be conjoined or conjoinable plastic objects.

In yet another aspect a method of assembling steel plates into an elongated strip comprises the steps of providing a series of assembly stations disposed at preselected distances apart, clamping a plate between the first and second support member in each of the assembly station, performing a first welding operation on adjacent plates, flipping all the support members and all the clamped and welded steel plate objects through 180 degrees of vertical rotation so as to simultaneously invert the first support members, the second support members, and the clamped plates through 180 degrees of vertical rotation; and thereafter performing a second welding operation on the now inverted plates so as to form an elongated steel strip.

The methods, systems, apparatuses are set forth in part in the description which follows, and in part will be obvious from the description, or can be learned by practice of the methods, apparatuses, and systems. The advantages of the methods, apparatuses, and systems will be realized and attained by means of the elements and combinations particularly pointed out in the appended claims. It is understood that both the foregoing general description and the following detailed description are exemplary and explanatory only and are not restrictive of the methods, apparatuses, and systems, as claimed.

### BRIEF DESCRIPTION OF THE DRAWINGS

In the accompanying figures, like elements are identified by like reference numerals among the several preferred embodiments of the present invention.

FIG. 1 is a perspective view of an example assembly station system.

FIG. 2 represents an assembly station in an open loading state.

FIG. 3 represents an assembly station in a closed loaded state.

FIG. 4 represents an assembly station in multiple rotational states.

FIG. 5 represents multiple assembly stations aligned to make a strip.

FIG. 6 is a perspective view of an example assembly station system in a rotated position.

Other aspects and advantages of the present invention will become apparent upon consideration of the following detailed description, wherein similar structures have similar reference numerals.

### DETAILED DESCRIPTION OF THE PREFERRED EMBODIMENTS

The foregoing and other features and advantages of the invention will become more apparent from the following detailed description of exemplary embodiments, read in conjunction with the accompanying drawings. The detailed description and drawings are merely illustrative of the invention rather than limiting, the scope of the invention being defined by the appended claims and equivalents thereof.

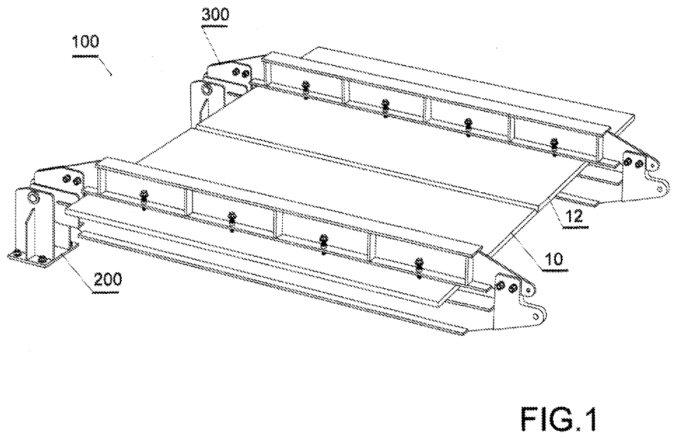

FIG. 1, represents an embodiment of the assembled system 100. As shown in FIG. 1, the system 100 comprises at least a first assembly station 200 and a second assembly station 300 adjacently aligned. Further, as shown in FIG. 1, in an assembled position, a first metal plate 10 is secured by the first assembly station 200 and a second metal plate 12 is secured adjacent to the first metal plate 10 by the second assembly station 300.

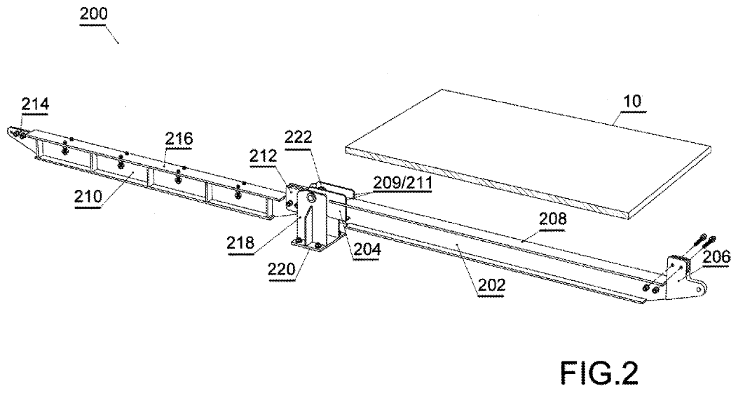

As shown in an open assembly position of FIG. 2, the first assembly station 200 comprises a first support member 202 having a first support member proximal end 204, a first support member distal end 206, and a first support member loading surface 208, a second support member 210 having a second support member proximal end 212, a second support member distal end 214, and a second support member loading surface 216 aligned with the first supported member 202, wherein the first support member 202 and the second support member 208 are rotatably coupled to a flip axle member 218. The flip axle member 218 further comprises a flip axle base 220 configured to be secured to a stable surface, and a flip axle 222 extending through the flip axle base 220. In the open assembly position, the second support member 210 is rotated opposite the first support member 202 about the flip axle 222.

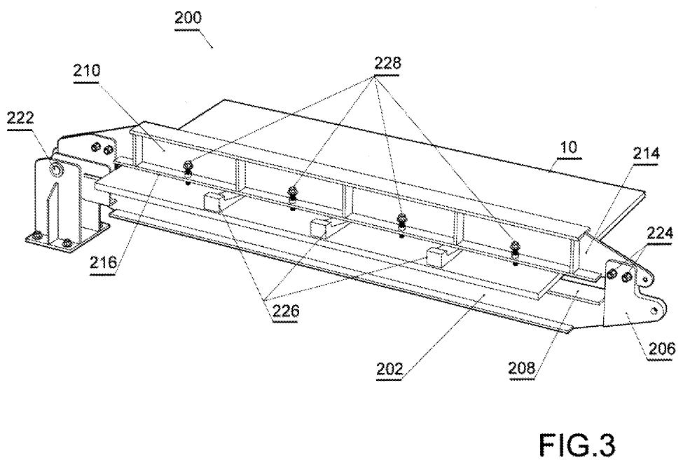

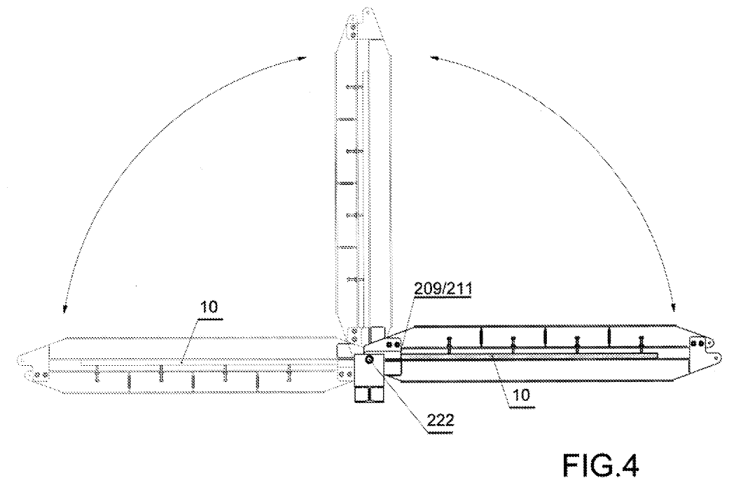

In operation, as shown in FIGS. 2 and 3, an object, such as a metal plate 10, is loaded onto the first support member loading surface 208 and secured in the first assembly station 200 by rotating the second support member 210 about the flip axle 222 into a closed position securing the plate 10 between the first support member loading surface 208 and the second support member loading surface 216. In the closed position the first support member distal end 206 and the second support member distal end 214 are in alignment. In some embodiments, the first support member further includes an alignment feature 209 extending from any one of the first support member proximal end 204, the first support member distal end 206, or from the first support member loading surface 208. The alignment feature 209 is adapted for an object or plate to abut next to and align with the station such that the object or plate is loaded a consistent position each time of use. The first support member 202 or second support member 210 may further comprise a vertical load bearing member 211 or feature configured to abut the object or metal plate and support the object or metal plate upon assembly station rotation. As an assembly station 200 rotates along the flip axis the distribution of the of the weight of the plate shifts from the first support member loading surface 208 to the load bearing member 211 halfway through rotation, and finally to the second support member loading surface 216 upon full rotation. In some examples, the alignment feature 209 may also serve to bear the weight load of the object and act as the load bearing member 211 as shown in FIG. 4.

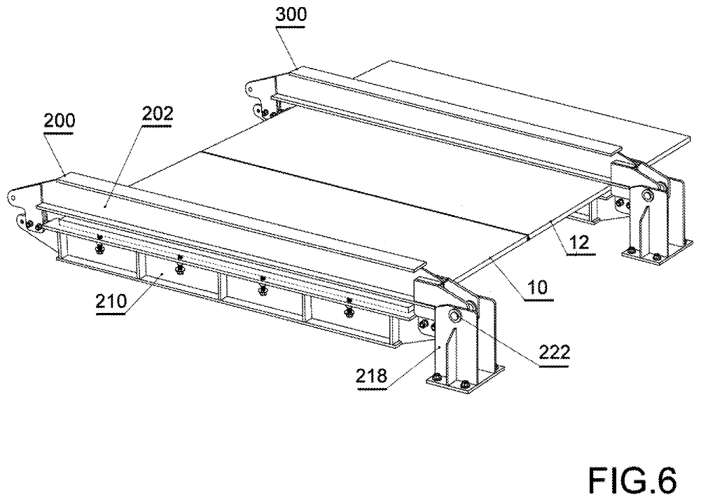

In one aspect, as shown in FIG. 3, the first support member distal end 206 and the second support member distal end 214 are fixed together through a securing mechanism 224. As shown, the securing mechanism may comprise at least one bolt or fastener extending through the first support member distal end 206 and the second support member distal end 214 and secured through a nut or similar device. In other aspects, the bolt may be threaded and lock into a complimentary threaded bore on the opposite support member. One of skill in the art would recognize that the securing mechanism can be any common fastener, threaded fastener, latch or even magnet. In some aspects, the flip axle member 222, may further comprise a preloaded hinge or locking hinge configured to rotate and lock when rotated into the closed position causing a clamping force to be applied to the plate by both the first support member loading surface 208 and the second support member loading surface 216. As shown in FIG. 4 and FIG. 6, after assembly, the assembled support member is free to rotate about the flip axle 222.

As further shown in FIG. 3, additional features such as spacers 226 or clamp force mechanisms 228 can be used to tighten the compression fit between the plate 10, first support member 202 and second support member 210 to further stabilize the plate. These additional features allow for a larger gap between first and second support members 202, 210 to be able to support plates or objects of varying sizes and still create the proper compression fit. For example, the spacers 226 may be adapted to fill the gap between the lower edge of the second support member 210 and the top surface of the plate 10 clamped between the first and second support members 202, 210. Whereas the clamp force mechanisms 228 may be a plurality of bolts threaded into one of the support members and spaced apart from adjacent bolts by substantially uniform distances. These bolts may be adapted to extend through one of said support members and adapted to compressively engage an object located between the first and second support members. One of skill in the art would also recognize the first support member loading surface 208 or the send support member loading surface 216 may further comprise a compressive member including, but not limited to a rubber or silicone configured to both grip the plate 10 and compress around the plate 10 to secure it in place between the first support member 202 and second support member 210.

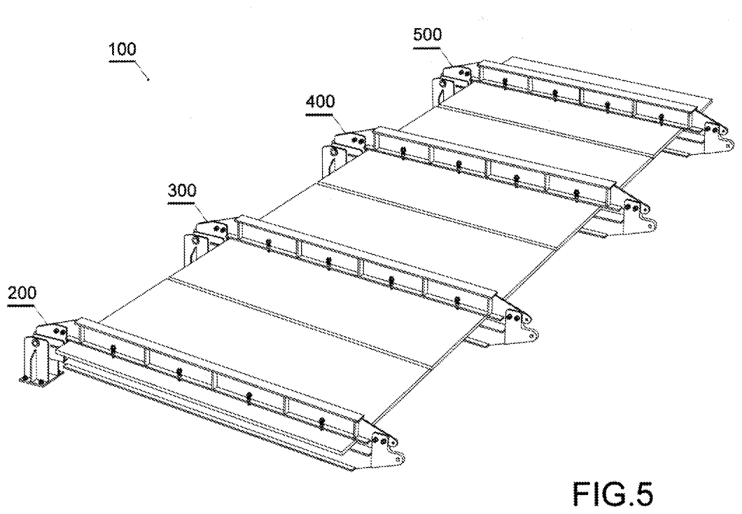

In another aspect, as shown in FIG. 5, the system 100 comprises a plurality of assembly stations 200, 300, 400, 500 spaced apart from adjacent stations at a predetermined distance. In this aspect, the confronting edges of objects in said adjacent stations are in such proximity to one another that the adjacent clamped objects can be conjoined to one another. Example objects include but are not limited to steel plates aligned adjacently to be conjoined.

In yet another aspect a method of assembling metal plates into an elongated strip comprises the steps of providing a series of assembly stations disposed at preselected distances a apart, determining a preselected spatial distance between the first and second support members of each assembly thereby allowing a steel plate object, clamping a steel plate between the first and second support member in each of the assembly station thereby arranging a series of steel plates in adjacent but confronting array, thereafter performing a first welding operation on adjacent plates, thereafter simultaneously flipping all the support members and all the clamped and welded steel plate objects through 180 degrees of vertical rotation so as to simultaneously invert the first support members, the second support members, and the clamped plates through 180 degrees of vertical rotation; and thereafter performing a second welding operation on the now inverted plates so as to form an elongated steel strip.

In some aspects of the method and system, a hoisting means is used to aid in the rotation of the assembled system 100. In this aspect, the hoisting means is coupled to the distal ends of the support members and used to lift and rotate the support members about the flip axle. One of skill in the art would appreciate that the hoisting means may be coupled to other portions of the assembled system 100, however, coupling to the distal ends of the support members provides for easiest axis and support rotation. Additionally one of skill in the art would appreciate that the hoisting means may include but is not limited to a traditional mechanical hoist, electrical driven hoist, pneumatic hoist, or even a crane.

Those of ordinary skill in the art will understand and appreciate the aforementioned description of the invention has been made with reference to certain exemplary embodiments of the invention, which describe a welding stabilization device, system and method of use. Those of skill in the art will understand that obvious variations in construction, material, dimensions or properties may be made without departing from the scope of the invention which is intended to be limited only by the claims appended hereto.

1. An assembly station for temporarily mounting an object comprising:
a first support member having a first support member proximal end, a first support member distal end, and a first support member loading surface;
a second support member having a second support member proximal end, a second support member distal end, and a second support member loading surface;
a flip axle member having a flip axle base configured to be secured to an external surface and a flip axle extending through the flip axle base;
the first support member rotatably coupled to the flip axle at the first support member proximal end;
the second support member rotatably coupled to the flip axle at the second support member proximal end such that the second support loading surface faces the first support loading surface; and
wherein when the second support member is rotated into an open position, the second support member loading surface faces the same direction as first support member loading surface and when the second support member is rotated into a closed position, the second support member loading surface faces the opposite direction as first support member loading surface and provides a clamping force securing an object disposed therebetween.

2. The assembly station of claim 1 wherein the first support member further comprises an alignment feature extending from the first support member proximal end adapted for the object to abut against upon loading.

3. The assembly station of claim 1 wherein the first support member further comprises a load bearing member extending from the first support member proximal end adapted to support a weight load of the object upon rotation of the assembly station.

4. The assembly station of claim 1 wherein the object is a metal plate.

5. The assembly station of claim 1 wherein the second support member is in a closed position and the first support member and second support member are fixed together through a securing mechanism at the first support member distal end and the second support member distal end.

6. The assembly station of claim 5 wherein the securing mechanism is at least one fastener, bolt, latch extending through or coupled to the first support member and the second support member.

7. The assembly station of claim 1 further comprising a compressive member configured to provide a compressive force between the object disposed between the first support member loading surface or the second support member loading surface in a closed position.

8. The assembly station of claim 6 wherein the compressive member is a rubber, synthetic rubber, or elastomeric material coupled to the first support member loading surface or the second support member loading surface.

9. The assembly station of claim 6 wherein the compressive member comprises at least one fastener extending through the first support member loading surface or the second support member loading surface configured to compressively engage the object between the first support member loading surface or the second support member loading surface.

10. The assembly station of claim 6 wherein the compressive member comprises at least one spacer adapted to fill a gap between a lower edge of the second support member and a top surface of the object or an upper edge of the first support member and a bottom surface of the object further securing the object.

11. An array of assembly stations according to claim 1, the assembly stations each being spaced apart from an adjacent station by pre-selected distance such as the confronting edges of objects in the adjacent stations are in such proximity to one another that the adjacent clamped objects can be conjoined to one another.

12. The array of assembly stations according to claim 11 in which objects in said adjacent stations are located in proximity to one another so that the objects can be conjoined by butt welding.

13. The array of assembly stations according to claim 11 further including a hoist means for simultaneously engaging a plurality of the adjacent assembly stations comprising the array and simultaneously rotating the assembly stations and objects clamped in between the support members so as to invert each first and second support member and the object clamped in between the first and second support members through 180 degrees of vertical rotation.

14. A method of assembling a plurality of plates into an elongated strip, the method comprising the steps of:
providing a series of assembly stations, each station having:
a first support member having a first support member proximal end, a first support member distal end, and a first support member loading surface;
a second support member having a second support member proximal end, a second support member distal end, and a second support member loading surface;
a flip axle member having a flip axle base configured to be secured to an external surface and a flip axle extending through the flip axle base;
the first support member rotatably coupled to the flip axle at the first support member proximal end;
the second support member rotatably coupled to the flip axle at the second support member proximal end such that the second support loading surface faces the first support loading surface; and
wherein when the second support member is rotated into an open position, the second support member loading surface faces the same direction as first support member loading surface and when the second support member is rotated into a closed position, the second support member loading surface faces the opposite direction as first support member loading surface and provides a clamping force securing a plate disposed therebetween;
loading the series of assembly stations with plates by placing the second support member in an open position, loading the plate onto the first support member loading surface, rotating the second support member into a closed position, fixing the second support member into the closed position thereby applying a compressive force between the first support member and the second support member onto the first plate, wherein each plate and assembly station are aligned to accommodate a weld in each gap between adjacently loaded plates; and
performing a welding operation welding adjacently loaded plates together securing each plate in series forming an elongated strip.

15. The method of assembling a plurality of plates into an elongated strip of claim 14 wherein the first support member further comprises an alignment feature extending from the first support member proximal end adapted, and the step of loading the plate onto the first support member loading surface includes the step of aligning the plate by abutting the plate against the alignment feature.

16. The method of assembling a plurality of plates into an elongated strip of claim 14 wherein the step of fixing the second support member into the closed position further comprises the steps of fixing a securing mechanism to the first support member distal end and second support member distal end.

17. The method of assembling a plurality of plates into an elongated strip of claim 14 wherein the step applying a compressive force between the first support member and the second support member onto the first plate further comprises the step of:
adding at least one fastener extending through the first support member loading surface or the second support member loading surface configured to compressively engage the between the first support member loading surface or the second support member loading surface; or
adding at least one spacer adapted to fill a gap between a lower edge of the second support member and a top surface of the object or an upper edge of the first support member and a bottom surface of the object further securing the object.

18. The method of assembling a plurality of plates into an elongated strip of claim 14 further comprising the step of simultaneously rotating the series of assembly stations about the flip axle of each assembly station and performing a second welding operation on an inverted side of the elongated strip, further securing the strip.

19. The method of assembling a plurality of plates into an elongated strip of claim 18 wherein the step of simultaneously rotating the series of assembly stations comprises using a hoisting means secured to the first support member distal end or second support member distal end, and hoisting the loaded support members and plates to rotate about the flip axis.

20. The method of assembling a plurality of plates into an elongated strip of claim 18 wherein the first support member further comprises a load bearing member extending from the first support member proximal end adapted to support a weight load of the object upon rotation of the assembly station and the step of comprising the step of simultaneously rotating the series of assembly stations about the flip axle of each assembly station comprises the step of transferring an object weight load from the first support member loading surface to the load bearing member and from the load bearing member to the second support member loading surface.
